(19) United States
(12) Patent Application Publication
(10) Pub. No.: US 2026/0265995 A1
(43) Pub. Date: Sep. 10, 2026

(54) POLYAMIDE FABRICS WITH REDUCED CARBON FOOTPRINT ON DYEING

(71) Applicant: NILIT LTD., Ramat (IL)

(72) Inventors: Richard Macret, San Paulo (BR); Michael Eliisha, Netanya (IL)

(73) Assignee: NILIT LTD., Ramat (IL)

(21) Appl. No.: 19/165,713

(22) PCT Filed: Apr. 3, 2024
(86) PCT No.: PCT/IL2024/050344

§ 371 Date: Sep. 16, 2025

(30) Foreign Application Priority Data
Apr. 10, 2023 (IL) 302039

(51) Int. Cl. D06P 3/26; C08G 69/28; C08K 3/22; D01F 6/80

(52) U.S. Cl. CPC D06P 3/26; C08G 69/28; C08K 3/22; D01F 6/80; C08K 2003/2241

(57) ABSTRACT

A process for dyeing a polyamide yarn or fabric, comprises the steps of: 1) polymerizing a nylon precursor comprising equimolar amounts of an amino groups source and a carboxy groups source, in a mixture further comprising an alfa,omega diamine in an amount corresponding to less than 2% of the amino groups contributed by said amino groups source, and a catalyst, in an amount of less than 100 ppm phosphorus relatively to the nylon precursor, having a formula [R—HP(═O)—O]ₙ-M or R—HP(═O)—OZ, wherein M is a metal preferably selected from the group consisting of sodium, potassium, calcium, barium, and lithium; R is selected from the group consisting of hydrogen, alkyl, cycloalkyl, aryl, and arylalkyl; n is a whole number corresponding to the valence of the metal; and Z is selected from the group consisting of hydrogen, alkyl, aryl, arylalkyl, and alkyl substituted ammonium cation, with the proviso that R and Z are not simultaneously hydrogen; and R and Z being alkylene when joined to form a ring structure; eventual water molecules in hydrated compounds are not shown; thereby obtaining a polyamide polymer exhibiting a concentration of amine end groups of at least 80 meq/kg; 2) spinning said polyamide polymer into a yarn, and optionally knitting said yarn into a fabric; and 3) dyeing said yarn or said fabric in a dyeing bath comprising a dyestuff in an amount of at least 1% of the weight of said yarn or fabric.

### FIELD OF THE INVENTION

The present invention relates to the field of polyamide textiles and specifically to modified polyamide yarns and fabrics that reduce the environmental load during dyeing.

The invention further relates to a process for dyeing polyamide textiles exhibiting a reduced carbon footprint.

### BACKGROUND OF THE INVENTION

Ever stricter environmental compliance and sustainability requirements also apply to the textile industry. For example, the Circular Economy Action Plan of the European Commission recognized that textiles are among the five highest-pressure categories for the use of primary raw materials and water and greenhouse gas emissions (https://ec.europa.eu/environment/circular-economy/pdf/new_circular_economy_action_plan.pdf). The worldwide textile production represents over 100 million tons annually, of which synthetic fibers constitute over 60%. In contrast to natural fibers, the production of synthetic fibers does not use agricultural resources, toxic pesticides, or fertilizers, but synthetic textiles affect the environment and climate through fossil resource use and by the emission of greenhouse gases and pollutants.

Nylons, synthetic polyamides, have remained popular since their invention in the 1940s, and their annual production may soon reach 10 million tons. They can be melt-processed into fibers, films, or shaped objects. Nylon fibers may have an environmental impact not only through the fossil fuel use during their production, but subsequently also during all manufacturing stages in their processing and utilizing. When trying to achieve a circular and more sustainable textile system, said manufacturing stages need to be carefully revised to discover important spots for improving the overall environmental impact of the system. Nylon yarns and fabrics are employed in producing a broad assortment of colorful textile products, and dyeing is an important step in producing fashionable apparel. It is therefore an object of this invention to reduce the environmental impact of the dyeing step in manufacturing the nylon textiles.

It is another object of this invention to provide modifications in the polyamide dyeing system which could contribute to lowering the environmental load of the nylon dyeing technology.

It is a further object of this invention to provide modifications in the nylon dyeing system, 10 which could lead to a reduction in the amounts of chemicals consumed and/or disposed of during the dyeing process.

It is also an object of this invention to provide a process for nylon dyeing which would reduce chemicals in wastewater.

It is another object of the invention to provide modifications in the nylon dyeing system which could lead to reducing the consumption of energy and/or water.

It is a further object of the invention to provide a process for dyeing polyamide yarn or 20 fabric exhibiting a lower environmental load, without reducing the quality of the dyed yarn or fabric.

It is also an object of the invention to provide an environmentally more friendly system for polyamide dyeing, enabling to reduce the carbon footprint of the dyeing stage.

The invention also aims at providing polyamide yarn and fabric with reduced carbon footprint while ensuring the best quality of the dyed textile products manufactured therefrom.

Other objects and advantages of present invention will appear as the description proceeds.

### SUMMARY OF THE INVENTION

This invention provides a process for dyeing a polyamide yarn or fabric, comprising steps of: i) polymerizing a nylon precursor comprising equimolar amounts of an amino groups source and a carboxy groups source in a mixture further comprising an alfa, omega diamine in an amount corresponding to less than 2% of the amino groups contributed by said amino groups source, and a catalyst in an amount corresponding to less than 100 ppm phosphorus relatively to the nylon precursor having a formula

[R—HP(═O)—O]ₙ-M or R—HP(═O)—OZ
wherein M is a metal preferably selected from the group consisting of sodium, potassium, calcium, barium, and lithium; R is selected from the group consisting of hydrogen, alkyl, cycloalkyl, aryl, and arylalkyl; n is a whole number corresponding to the valence of the metal; and Z is selected from the group consisting of hydrogen, alkyl, aryl, arylalkyl, and alkyl substituted ammonium cation, with the proviso that R and Z are not simultaneously hydrogen; R and Z being alkylene when joined to form a ring structure; eventual water molecules in hydrated compounds are not shown; thereby obtaining a polyamide polymer exhibiting a concentration of amine end groups of at least 80 meq/kg; ii) spinning said polyamide polymer into a yarn and optionally knitting said yarn into a fabric; and iii) dyeing said yarn or said fabric in a dyeing bath comprising a dyestuff in an amount of at least 1% of the weight of said yarn or fabric, in a preferred embodiment of the invention at least 2%. The process of the invention exhibits a lower environmental load of the dyeing process, resulting in a lower dyestuff consumption, a lower fixative consumption, reduced chemicals in wastewater, reduced COD (Chemical Oxygen Demand) in wastewater, and an increased color fastness of the dyed yarn or fabric. Said precursor may be a lactam, or it may be a nylon salt consisting of equimolar amounts of alfa,omega diamine and alfa,omega dicarboxylic acid. In a preferred embodiment of the process of the invention, said nylon salt is composed of an equimolar mixture of adipic acid and hexamethylene diamine, and said α,ω-diamine is hexamethylene diamine in an amount of about 0.5% of the weight of said nylon salt, added in aqueous solution. Said mixture may comprise water, for example in an amount of 25% of said nylon precursor, manganese (II) acetate tetrahydrate, for example in an amount of about 20 ppm relatively to the nylon precursor. In one preferred embodiment of the invention, said catalyst is sodium hypophosphite.

In a preferred embodiment of the process according to the invention, said polymerizing step starts under nitrogen pressure of 15 to 20 bar. The mixture is preferably heated to about 195° C., followed by addition of an aqueous slurry of TiO₂ to reach about 0.3% TiO₂ relatively to the final nylon polymer (for example 1160 g hexamethylenediamine-adipic acid nylon salt provides about 1000 g of nylon polymer). The temperature is then preferably raised to 245° C. This first stage of heating the mixture takes a period of time depending on the equipment and the salt amount. The pressure is then lowered to less than 1 bar, for example to a pressure of 0.6-0.95 bar, such as 0.7-0.9 bar, and the reaction is continued for the same period of time also in this second heating stage.

The invention relates to a polyamide polymer comprising amine end groups at a concentration of at least 80 meq/kg and a relative viscosity (1% in 96% sulfuric acid) of at least 2.2, obtained by a polymerization process in a mixture comprising a nylon precursor being an equimolar mixture of an amino groups source and a carboxy groups source, an α,ω-diamine in an amount corresponding to less than 2% amino groups contributed by said amino groups source, and sodium hypophosphite in an amount corresponding to between 5 and 20 ppm phosphorus relatively to said precursor, wherein said precursor is a lactam, or a nylon salt consisting of equimolar amounts of alfa,omega diamine and alfa,omega dicarboxylic acid. The invention further relates to a polyamide yarn or fabric spun or knitted from the above polymer, comprising amine end groups at a concentration of at least 80 meq/kg, a yarn denier of about 20 to about 250, and a tenacity of about 2.5 grams/denier to about 7.0 grams/denier, said yarn or fabric exhibiting an increased color fastness after dyeing. In a preferred embodiment of the invention, said nylon salt for obtaining said yarn or fabric is an equimolar mixture of adipic acid and hexamethylene diamine, and said amine end groups concentration is preferably between 85 and 110 meq/kg, while said relative viscosity is between 2.5 and 2.8.

The invention provides a system of polyamide dyeing, which system lowers the environmental load of the textile industry and reduces its carbon footprint, comprising dyeing polyamide yarn or fabric in a bath containing a textile dye in an amount corresponding to at least 1%, preferably 1.5% or more, such as 2% or more of the weight of said yarn or fabric, wherein said yarn or fabric exhibits amine end groups at a concentration of at least 80 meq/kg and is obtained in a polymerization mixture comprising a nylon precursor consisting of an equimolar amounts of an amino groups source and a carboxy groups source, an α,ω-diamine in an amount corresponding to between 0.5 and 2% of the amino groups contributed by said amino groups source, and optionally a phosphorus catalyst, in an amount of up to 100 ppm relatively to said precursor, having a formula

[R—HP(═O)—O]ₙ-M or R—HP(═O)—OZ
wherein M is a metal preferably selected from the group consisting of sodium, potassium, calcium, barium, and lithium; R is selected from the group consisting of hydrogen, alkyl, cycloalkyl, aryl, and arylalkyl; n is a whole number corresponding to the valence of the metal; and Z is selected from the group consisting of hydrogen, alkyl, aryl, arylalkyl, and alkyl substituted ammonium cation, with the proviso that R and Z are not simultaneously hydrogen; and R and Z being alkylene when joined to form a ring structure. Said precursor in the system according to the invention may be a lactam, or a nylon salt consisting of equimolar amounts of alfa,omega diamine and alfa,omega dicarboxylic acid. In a preferred embodiment, the system of the invention comprises said catalyst in an amount of from 5 to 20 ppm. In another preferred embodiment, the polymerization mixture in the system of the invention is heated in two stages, the first one at a pressure of 15-20 bar and the second one at a pressure of 0.7-0.9 bar. In one preferred embodiment of the system according to the invention, said nylon salt is composed of an equimolar mixture of adipic acid and hexamethylene diamine, said α,ω-diamine is hexamethylene diamine in an amount of about 0.5% of the weight of said nylon salt, said catalyst is sodium hypophosphite, and said pressure in the second stage is 0.8-0.9 bar.

The above and other characteristics and advantages of the invention will be more readily apparent through the following examples, and with reference to the appended drawing.

### BRIEF DESCRIPTION OF THE DRAWINGS

FIG. 1 shows two spectrophotometer curves of wastewater after dyeing, the higher curve belonging to the reference process and the lower curve to the process according to the invention. The benefit of dyestuff reduction in the wastewater of the process according to the invention is clearly seen.

### DETAILED DESCRIPTION OF THE INVENTION

It has now been found that specific modifications in the polyamide manufacturing process may substantially contribute to lowering the environmental load of the textile industry, particularly nylon production and more particularly during its dyeing stage. The invention relates to modified polyamides (PA) and fibers made therefrom, and to processes for producing them, wherein said PA and said fibers comprise an amino end group concentration of at least 80 meq/kg, relative viscosity (1% in 96% sulfuric acid) of at least 2.2, a yarn denier of about 20 to about 250, a tenacity of about 2.5 grams/denier to about 7.0 grams/denier, and wherein said processes comprise, beside a nylon precursor comprising equimolar amounts of an amino groups source and a carboxy groups source, a minor excess of amines in the form of a diamine in the polymerization mixture above the equimolar ratio of amine to carboxy groups in the sources. Said excess of amines is preferably between 0.5 and 2.5 molar % of the amines provided in said amino groups source. In one embodiment of the invention, the process preferably comprises employing phosphorus catalysts during the polycondensation stage. In another embodiment of the invention, the second stage of heating during the polymerization comprises a pressure lower than the atmospheric pressure. In a preferred embodiment of the invention, the process comprises employing the catalyst and the lowered pressure. The catalyst concentration may be 0-100 ppm relatively to the nylon precursor, such as 5-25 ppm. Said lowered pressure during the last stage of heating may be, for example, about 0.7-0.9 atm. Said modified PA and processes exhibit a lower environmental load of the dyeing process, and result in lower dyestuff consumptions, lower fixative consumptions, lower temperatures, reduced chemicals in wastewater, reduced COD (Chemical Oxygen Demand) in wastewater, reduced water and energy consumptions, and surprisingly also an increased color fastness. For example, when dyeing nylon 66 fabric prepared according to the invention, usual temperatures of the dyeing bath of 96-98° C. may be lowered to 85-87° C. without negative effects on the final quality. The technology is thus relatively environmentally more friendly and reduces the carbon footprint.

The advantages are demonstrated below for nylon 66 but hold for all kinds of polyamides, and also copolymers thereof as far as admixed comonomers constitute less than 5 molar % of the main monomers, preferably 2.5 molar % or less. For example, up to 2.5% caprolactam may be advantageously admixed in the polymerization mixture of nylon 66 when adjusting the crystalline properties of the final polymer. The invention relates preferably to yarns and fabrics consisting of one type of polymer fiber, one type of nonbranched polyamide fiber, without changing the basic intramolecular polyamide structure and the usual intermolecular interactions, with enhanced amino end groups incorporated during the polymerization process by adding an excess of the amine component to the stochiometric mixture of amine and carboxyl donors, said component added in the form of a diamine, in an amount corresponding to between 0.5 and 2.5 molar percent of the amine groups contributed by said amine donor.

This invention relates to fabrics produced from modified polyamide yarns that bring sustainable advantages to the dyeing process. The fabrics allow for reducing the quantity of dyestuff and additives in wastewater effluent during the dyeing process, resulting among others in lowered COD, and also for improving color fastness. According to the invention, the modified yarns are obtained by a change in the polyamide polymer. It can be applied to different polyamides including polyamide 4, polyamide 6, polyamide 46, polyamide 66, polyamide 7, polyamide 8, polyamide 9, polyamide 610, polyamide 1010, polyamide 11, polyamide 12, polyamide 13, polyamide 612, polyamide 9T, and polyamide 13, and copolymers thereof.

In general, polyamide (PA) or nylon is a condensation polymer composed of repeated amide groups —CONH—, exhibiting good chemical and abrasion resistance and enabling a broad scope of manufacturing techniques. Excellent mechanical properties of PA, including tensile strength, impact resistance, elasticity and tenacity, ensure its ever increasing use in the textile industry. Beside methylene groups —CH₂— and amide groups —NHCO— in the middle of the molecular chains, PA is characterized by carboxyl groups —COOH and amino groups —NH₂ at the ends of the chains. The interchain hydrogen bonds between adjacent amide groups contribute to the special nylon properties. Beside the principal amino- and carboxy-monomers, other co-monomers are sometimes added during the polymerization process to modify PA characteristics, an example being 5-sulfoisophthalic acid sodium salt which adds —SO₃Na groups to the chain, or caprolactam which affects the crystallinity of polyamide 66; other additives may modify the end groups, for example by adding acetyl or methyl moieties to the end amino groups. The amounts of chemical groups along the polymer chain and at its ends (usually expressed as meq/kg polymer), as well as the ratios thereof, influence the polymer features, often in a hardly predictable mode, including mechanical and chemical properties, thus affecting also the polymer processability, including its dyeing properties.

The invention relates to the use of a modified polyamide to produce textiles fabrics or industrial yarns fabrics. The PA in accordance with the invention is a melt spun polyamide polymer comprising amino end groups in an amount of at least 80 meq/kg, preferably between 80 and 150, such as between 85 and 120, for example between 90 and 110. The relative viscosity of the PA (1% in 96% sulfuric acid) is at least 2.2, preferably between 2.4 and 3.0, such as between 2.5 and 2.7, for example between 2.6 and 2.7. The yarn denier is preferably from about 20 to about 250, the tenacity is about 2.5 grams/denier to about 7.0 grams/denier.

Comparing two fabrics being dyed in dark colors, one produced with a reference yarn and the second in parallel with the modified polyamide yarn as described above, provides the following differences: The fabric according to the invention requires less dyestuff to reach the same color shade and, even more importantly, the dyeing wastewater contains much less dyestuff and has lower COD. Moreover and surprisingly, the fabrics according to the invention exhibit a better color fastness. When combining all the features of the invention, an important reduction of the carbon footprint is obtained for the dyeing step. The mentioned benefits depend on the weight ratio of the employed dyestuff and the dyed fabric. The advantages start to be marked for the dye to fabric weight ratios above 0.01.

Usual techniques for polyamide synthesis typically provide 35-50 meq/kg free amino groups (https://textilelearner.net/nylon-66-fiber-applications/). The yarn used to produce the fabrics with advantageous dyeing properties in accordance with the invention have end amino groups in an amount of at least 80 meq/kg. Not all methods for increasing the free amino groups produce the desired benefits during the dyeing process. Some techniques, for example, employing polyamines during the polymerization process, such as diethylene triamine, triethylene tetramine, tetraethylene pentamine, pentaethylene hexamine, hexaethylene heptamine, or polyethylene polyamine, do not lead to polyamides suitable for the use in accordance with the invention, even though providing an increased amount of amino end groups. Other techniques employ an excessive amount of hindered amines, such as hindered piperidine derivatives, but the resulting polymer does not exhibit the desired dyeing properties in accordance with the invention either. The polyamide for yarns and fabrics in accordance with the invention are preferably prepared from reaction mixtures with slight excess of amines; in preferred embodiments of the invention, the amine group donors are diamines, for example selected from propane-1,3-diamine, butane-1,4-diamine, pentane-1,5-diamine, hexane-1,6-diamine, decane-1,10-diamine, or m-xylylenediamine.

The polyamide in accordance with the invention comprises amino end groups in an amount of at least 80 meq/kg and a relative viscosity (1% in 96% sulfuric acid) of at least 2.2, being prepared in a polymerization reaction employing a catalyst of a formula selected from:

[R—HP(═O)—O]ₙ-M or R—HP(═O)—OZ
wherein M is a metal preferably selected from the group consisting of sodium, potassium, calcium, barium, and lithium; R is selected from the group consisting of hydrogen, alkyl, cycloalkyl, aryl, and arylalkyl; n is a whole number corresponding to the valence of the metal; and Z is selected from the group consisting of hydrogen, alkyl, aryl, arylalkyl, and alkyl substituted ammonium cation, with the proviso that R and Z are not simultaneously hydrogen; R and Z being alkylene when joined to form a ring structure; eventual water molecules in hydrated compounds are not shown.

The amount of the catalyst added to the reaction mixture should preferably correspond to between 2 and 100 ppm of phosphorus, often advantageously between 5 to 25 ppm, relatively to the nylon precursors. The polymerization pressure during the first stage of heating is preferably between 15 and 20 atm, and during the second stage of heating between 0.5 and 1 atm, preferably between 0.7 and 0.9 atm.

Fabrics produced from the yarns described above, exhibiting amino end groups around 90 meq/kg were dyed in dark color (dyestuff/fabric weight ratio=0.04), in parallel with reference fabrics produced from yarns exhibiting amino end groups around 50 meq/kg. Surprisingly, it turned out that, in order to reach the same color in the fabric according to the invention, the amount of dyestuff had to be reduced by about 5%, while the dyestuff appearing in the wastewater decreased by 23%; COD of the wastewater was reduced by about 20%. The reductions depended on the desired textile color and the used dyestuff type, but the tendency was always the same. In general, the relative reductions are higher for darker fabric colors (which are in greater demand) and disappear in lighter fabric colors; essentially the marked advantages appear when dyestuff/fabric weight ratio is higher than 0.01.

Other parameters of the dyeing process in accordance with the invention further contribute to the reduction of the carbon footprint. Beside cleaner wastewater and lower residual dyestuff, the dyeing process according to the invention reduces the number of washing cycles, the heat energy, the water volume, and the cooling energy. The invention allows for these reductions without any negative impact on the color and other qualities of the final dyed fabric. Another unexpected result concerns the color fastness: the invention allows for a reduction of up to 50% of the amount of fixative, compared to the reference fabric, while achieving the same or better fastness.

The invention will be further described and illustrated by the following examples.

### EXAMPLES

### Equipment

Polyamide 66 polymerization autoclave; POY Barmag spinning machine; Seamless machine SANTONI Sm8-8 TOP; UV Spectrophotometer—VIS Shimadzu UV 2600; DTY Barmag FKF equipment; COD (Chemical Oxygen Demand)—HACH DR/2010 equipment; Color Flex EZ Hunter Lab equipment.

### Example 1

A first polymer was prepared by adding the following reagents into a stainless-steel autoclave: 1159 kg of nylon salt composed of adipic acid and hexamethylene diamine (aiming at 1000 kg polymer) and water to make 80% aqueous mixture, pH 7.59; 25 g of manganese (II) acetate tetrahydrate; and 0.6 kg acetic acid to adjust viscosity. The autoclave was purged with nitrogen and heated until 195° C. at 17.5 bar (pressurized with nitrogen); the pressure was kept by a control valve and the temperature continued to rise; 15 min after the pressure reached 17.5 bar, 15 kg of 20% aqueous slurry of TiO₂ was added (to reach the weight concentration of about 0.3% based on the final polymer weight). The heating was continued until the temperature reached 245° C. at 17.5 bar. After this first heating stage, the pressure was reduced to 1 bar, and the polycondensation reaction continued for 35 min. The molten polymer was granulated in cylindrical pellet form. The polymer had a relative viscosity of 2.6 and a concentration of amine ends of 45 meq/kg. The pellets were spun into 50 denier and 34 filaments yarn at a rate of 4500 m/min. The spun bobbins were transferred to a texturize machine and the final product was 2 bobbins with Z twist of 40 denier yarn with 34 filaments, 2 bobbins of the same yarn with S twist, and 4 bobbins with 2 plies of this yarn forming a 80 denier by 68 filaments. The tenacity was of 3.9 grams/denier.

A second polymer was produced in the same manner as described above except for adding 6 kg of hexamethylene diamine plus water to make it 50%, and 30 g of sodium hypophosphite (NaH₂PO₂·H₂O); no acetic acid was used. The polymerization was performed as above, but the second heating stage was performed at an absolute pressure of 0.85 bar (vacuum of 0.15 bar) during 30 min. The polymer had a relative viscosity of 2.65 and a concentration of amine end groups of 92 meq/kg. The same yarns were produced as described above.

A minor addition of the amine source to the equimolar mixture of the amine source and the carboxy source (to the nylon salt), together with the described changes including the catalyst and/or the vacuum, provided the desired amino end group difference.

The yarns were loaded on to a seamless knitting machine. Seamless knitted sleeves of the two different types were produced to perform dyeing comparisons.

The sleeves were dyed with Lanaset Black B.

TABLE 1
Dyeing with Metal Complex (Lanaset Black B)

| Fabric | Reference | Invention |
|---|---|---|
| Dyestuff (% weight of the fabric) | 5 | 4.5 |
| L | 10.48 | 10.20 |
| a | 0.15 | 0.02 |
| b | −1.31 | −1.21 |

Dyestuff concentration in the wastewater was 5 kg/m³ for the Reference and 2 kg/m³ for the Invention.

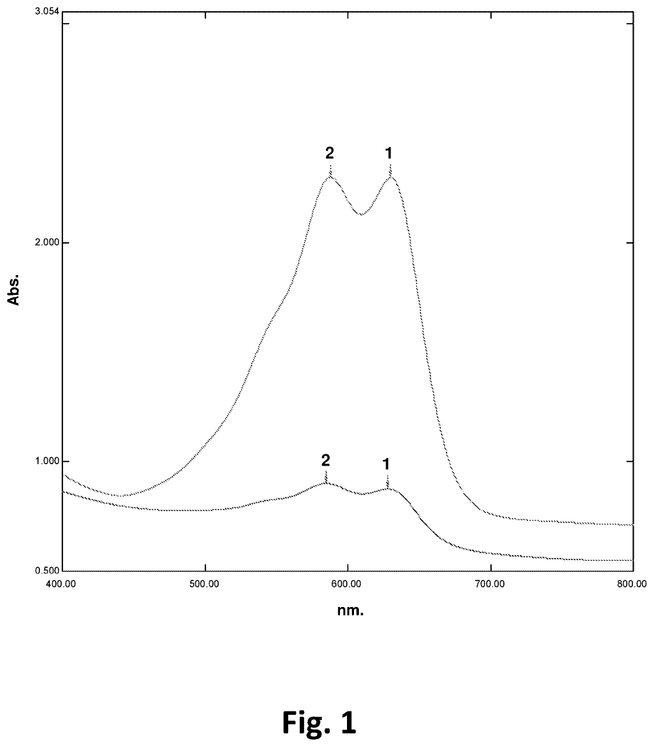

The spectrophotometric absorption curves show the reduction of the dye in the wastewater (FIG. 1). The benefit of dyestuff reduction is clearly seen. The same color of the textile was achieved, despite 10% lower amount of the dye in the modified textile.

### Example 2

The sleeves prepared in Example 1 were dyed with 3% TOPACID RED 2BB (Milling). After dyeing, the fabrics passed to a fixation bath to increase the dyeing fastness. The table below shows the results of the fastness test. The quality rating assigns 0-5 points, 5 points corresponding to the best and 0 points to the worst quality.

TABLE 2
Dyeing with TOPACID RED 2BB and characterizing fastness.

| | TRAIL | | | | | |
|---|---|---|---|---|---|---|
| | 1 | | 2 | | 3 | |
| | Fixing agent | | | | | |
| | 5% | | 2.5% | | 0% | |
| Fastness test | Reference | Invention | Reference | Invention | Reference | Invention |
| Laundering | 4-5 | 4-5 | 4-5 | 4-5 | bad | 4 |
| Perspiration acid | 4-5 | 4-5 | 4 | 4-5 | bad | 4 |
| Perspiration alka. | 4-5 | 4-5 | 3-4 | 4-5 | bad | 3 |
| Cold water | 4-5 | 4-5 | 4 | 4-5 | bad | 4 |
| Crocking solid | 4 | 4-5 | 4 | 4-5 | bad | 4 |

The Invention shows better results when compared to the Reference, even when using only a half of the amount of the fixing agent.

The Reference test using 5% fixation agent (weight relatively to dry fabric) showed 1280 ppm of the wastewater COD (Chemical Oxygen Demand), whereas the Invention test using 2.5% fixation agent showed wastewater COD value of 1050 ppm.

### Example 3

During the spinning of the reference yarn of Example 1, a source of hindered amino groups, NYLOSTAB S-EED FF, in an amount of 1%, was added (Clariant: 1,3-benzenedicarboxamide, N,N′-bis(2,2,6,6-tetramethyl-4-piperidinyl)). Said source has 2 hindered amino group per molecule corresponding to 4566 meq/kg. The addition brought the amino end groups of the reference yarn to 90 meq/kg. This new reference fabric exhibiting 90 meq/kg amino end groups and the original reference fabric of Example 1 exhibiting 45 meq/kg amino end groups were dyed and compared.

TABLE 3
Example of Dye Process, The dyeing comprised
3% Erionyl Navy - 98° C. for 45 min; Univadine
MC (leveler) 1 g/l, AVCOCID HTA-1000 2 g/l.

| Fabric | Reference | Reference + additive |
|---|---|---|
| Dyestuff (% weight of the fabric) | 3 | 3 |
| L | 17.19 | 17.05 |
| a | 4.35 | 4.03 |
| b | −23.79 | −23.45 |

Dyestuff concentration in the wastewater was 4.5 kg/m³ for Reference, and 4.4 kg/m³ for Invention.

The results showed no clear differences in dyestuff reductions (the used dye amount to reach the same color or the dye amount in the wastewater) for the two fabrics. It demonstrates that simple increase of the end amino groups does not necessarily provide the benefit and the desired advantages, if the PA is not produced in accordance with the invention.

### Example 4

Seamless fabrics with the different yarns were dyed with different dye bath concentrations. Wavelength used to measure the dyestuff concentration was 627 nm.

TABLE 4
Dyeing with metal complex Lanaset Blue 2R, initial pH was 5.5, ratio
water/fabric was 50; the Table shows the process parameters.

| | Dyestuff/ | | Wastewater | | Total | | | |
|---|---|---|---|---|---|---|---|---|
| | weight of | Initial bath | dyestuff | | dyestuff | Absorbed | Remaining | Comments |
| Sample | fabric | concentration | concentration | Loss | weight (g) | (g) | (g) | (wastewater color) |
| Reference | 4% | 0.065% | 0.0147% | 22.7% | 0.48 | 0.37 | 0.11 | Dark blue color |
| Invention | 4% | 0.065% | 0.0019% | 3.0% | 0.48 | 0.47 | 0.01 | Light blue color |
| Reference | 2% | 0.039% | 0.0051% | 13.1% | 0.24 | 0.21 | 0.03 | Medium blue color |
| Invention | 2% | 0.039% | 0.0011% | 2.8% | 0.24 | 0.23 | 0.01 | Light blue color |
| Reference | 0.50% | 0.011% | 0.0000% | 0.0% | 0.06 | 0.06 | 0.00 | No visible blue |
| Invention | 0.5% | 0.011% | 0.0000% | 0.0% | 0.06 | 0.06 | 0.00 | No visible blue |
| Reference | 0.05% | 0.001% | 0.0000% | 0.0% | 0.006 | 0.01 | 0.00 | No visible blue |
| Invention | 0.05% | 0.001% | 0.0000% | 0.0% | 0.006 | 0.01 | 0.00 | No visible blue |

TABLE 5
Dyeing with metal complex Lanaset Blue 2R, initial pH was 5.5, ratio
water/fabric was 50; the Table shows the fabric color parameters.

| Sample | L* | a* | b* | Comments |
|---|---|---|---|---|
| Reference | 29.9 | 11.6 | −45.4 | Very dark blue |
| Invention | 27.3 | 13.0 | −45.4 | Very dark blue |
| Reference | 36.3 | 9.0 | −45.6 | Dark blue |
| Invention | 35.7 | 8.6 | −44.7 | Dark blue |
| Reference | 53.9 | 2.0 | −38.3 | Medium blue shade |
| Invention | 54.0 | 1.4 | −37.0 | Medium blue shade |
| Reference | 76.4 | −3.6 | −17.1 | Very light blue |
| Invention | 76.5 | −3.8 | −15.6 | Very light blue |

It can be concluded that the dyestuff losses in the wastewater depend on the initial dyestuff concentration, becoming important for initial dyestuff amounts in the bath higher than 1% of the fabric weight, mainly for the reference fabric. For lower dye/fabric ratios like 0.5% (weight ratio of 0.005), the benefit disappears. The dyestuff losses increase with the dye concentration, but more for the reference fabric than the fabric according to the invention. For dye/fabric ratios higher than 2%, the final fabric colors of the invention are darker. It means that a reduction of the used dye amount would be needed to reach the same color, which will reduce still more the dyestuff in wastewater. No differences in color were seen for initial dyestuff ratios of 0.05% and 0.5%.

### Example 5

Seamless fabrics with the different yarns were dyed with different dye bath concentrations. Wavelength used to measure the dyestuff concentration 628 nm.

TABLE 6
Dyeing with acid dyestuff Erionyl Blue AR, initial pH was 5.5, weight
ratio water/fabric was 50; the Table shows the process parameters.

| | Dyestuff/ | | Wastewater | | Total | | | |
|---|---|---|---|---|---|---|---|---|
| | weight of | Initial bath | dyestuff | | dyestuff | Absorbed ® | Remaining | Comments |
| Sample | fabric | concentration | concentration | Loss | weight (g) | (g) | (g) | (wastewater color) |
| Reference | 4% | 0.090% | 0.0041% | 4.6% | 0.66 | 0.63 | 0.03 | Dark blue color |
| Invention | 4% | 0.090% | 0.0008% | 0.9% | 0.66 | 0.66 | 0.01 | Light blue color |
| Reference | 2% | 0.045% | 0.0004% | 1.0% | 0.28 | 0.28 | 0.00 | Medium blue color |
| Invention | 2% | 0.045% | 0.0004% | 0.8% | 0.28 | 0.28 | 0.00 | Light blue color |
| Reference | 0.50% | 0.011% | 0.000% | 0.0% | 0.06 | 0.06 | 0.00 | No visible blue |
| Invention | 0.50% | 0.011% | 0.0000% | 0.0% | 0.06 | 0.06 | 0.00 | No visible blue |
| Reference | 0.05% | 0.001% | 0.0000% | 0.0% | 0.006 | 0.006 | 0.00 | No visible blue |
| Invention | 0.05% | 0.001% | 0.0000% | 0.0% | 0.006 | 0.006 | 0.00 | No visible blue |

TABLE 7
Dyeing with acid dyestuff Erionyl Blue AR, initial
pH was 5.5, weight ratio water/fabric was 50;
the Table shows the fabric color parameters.

| Sample | L* | a* | b* | Comments |
|---|---|---|---|---|
| Reference | 27.6 | 17.1 | −51.4 | Very dark blue |
| Invention | 26.5 | 18.2 | −51.7 | Very dark blue |
| Reference | 35.5 | 12.0 | −51.0 | Dark blue |
| Invention | 35.0 | 12.4 | −51.3 | Dark blue |
| Reference | 53.0 | 2.9 | −42.9 | Medium blue shade |
| Invention | 52.2 | 3.0 | −43.5 | Medium blue shade |
| Reference | 76.2 | −4.2 | −18.1 | Very light blue |
| Invention | 76.2 | −4.5 | −18.0 | Very light blue |

It can be concluded that the dyestuff losses in the wastewater depend on the initial dyestuff amount, becoming very important for 2% dye or more (=dyestuff/fabric weight ratio of at least 0.02) mainly for the reference fabric. It can also be noticed that the losses depend on the type of the employed dye. The dyestuff losses increase with the initial dye amounts, but more for Reference fabric than for Invention fabric. The differences become very low for dyestuff amounts of 0.5% or less. For amounts higher than 2%, the final colors of the invention textiles are darker. It means that reducing the initial concentration would be allowed to reach the same color, which reduces even more the dyestuff in wastewater.

While the invention has been described using some specific examples, many modifications and variations are possible. It is therefore understood that the invention is not intended to be limited in any way, other than by the scope of the appended claims.

1. A process for dyeing a polyamide yarn or fabric, comprising steps of:
i) polymerizing a nylon precursor comprising equimolar amounts of an amino groups source and a carboxy groups source, in a mixture further comprising an alfa,omega diamine in an amount corresponding to less than 2% of the amino groups contributed by said amino groups source, and a catalyst, in an amount of less than 100 ppm phosphorus relatively to the nylon precursor, having a formula
[R—HP(═O)—O]ₙ-M or R—HP(═O)—OZ
wherein M is a metal preferably selected from the group consisting of sodium, potassium, calcium, barium, and lithium; R is selected from the group consisting of hydrogen, alkyl, cycloalkyl, aryl, and arylalkyl; n is a whole number corresponding to the valence of the metal; and Z is selected from the group consisting of hydrogen, alkyl, aryl, arylalkyl, and alkyl substituted ammonium cation, with the proviso that R and Z are not simultaneously hydrogen; and R and Z being alkylene when joined to form a ring structure; eventual water molecules in hydrated compounds are not shown; thereby obtaining a polyamide polymer exhibiting a concentration of amine end groups of at least 80 meq/kg;
ii) spinning said polyamide polymer into a yarn, and optionally knitting said yarn into a fabric; and
iii) dyeing said yarn or said fabric in a dyeing bath comprising a dyestuff in an amount of at least 1% of the weight of said yarn or fabric.

2. A process according to claim 1, exhibiting a lower environmental load of the dyeing process, resulting in a lower dyestuff consumption, a lower fixative consumption, reduced chemicals in wastewater, reduced COD (Chemical Oxygen Demand) in wastewater, and an increased color fastness of the dyed yarn or fabric.

3. A process according to claim 1, wherein said precursor is a lactam, or a nylon salt consisting of equimolar amounts of alfa,omega diamine and alfa,omega dicarboxylic acid.

4. A process according to claim 3, wherein said salt is composed of equimolar adipic acid and hexamethylene diamine, and wherein said alfa,omega diamine is hexamethylene diamine in an amount of about 0.5% of the weight of said nylon salt.

5. A process according to claim 1, wherein said mixture further comprises water in an amount of approximately 25% of said precursor, manganese (II) acetate tetrahydrate in an amount of 20 ppm relatively to said precursor, and wherein said catalyst is in an amount of from 5 to 20 ppm.

6. A process according to claim 1, wherein said catalyst is sodium hypophosphite.

7. A process according to claim 1, wherein said polymerizing is performed under nitrogen pressure of 15 to 20 bar; the mixture is heated to about 195° C., aqueous slurry of TiO₂ is added to reach about 0.3% TiO₂ relatively to the final nylon polymer, the temperature is raised to 245° C., this first heating stage lasting a period of time depending on the equipment and the salt amount; the pressure is lowered to less than 1 bar (moderate vacuum) and the reaction is continued for the same period of time during this second heating stage.

8. A polyamide polymer comprising amine end groups at a concentration of at least 80 meq/kg and a relative viscosity (1% in 96% sulfuric acid) of at least 2.2, obtained by a polymerization process in a mixture comprising a nylon precursor being an equimolar mixture of an amino groups source and a carboxy groups source, an alfa,omega diamine in an amount corresponding to less than 2% of the amino groups contributed by said amino groups source, and sodium hypophosphite in an amount corresponding to 5-20 ppm phosphorus relatively to said precursor, wherein said precursor is a lactam, or a nylon salt consisting of equimolar amounts of alfa,omega diamine and alfa,omega dicarboxylic acid.

9. A polyamide yarn or fabric spun or knitted from the polymer of claim 8, comprising amine end groups at a concentration of at least 80 meq/kg, a filament denier of from about 20 to about 250, and a tenacity of from about 2.5 grams/denier to about 7.0 grams/denier, exhibiting an increased color fastness after dyeing, said polymer obtained by a polymerization process in a mixture comprising a nylon precursor being a lactam, or a nylon salt consisting of equimolar amounts of alfa,omega diamine and alfa,omega dicarboxylic acid.

10. A yarn or fabric according to claim 9, wherein said nylon salt is an equimolar mixture of adipic acid and hexamethylene diamine, and wherein said amine end groups concentration is 85-110 meq/kg.

11. A system of polyamide dyeing, lowering the environmental load of the textile industry and reducing its carbon footprint, comprising dyeing polyamide yarn or fabric in a bath comprising a dye in an amount corresponding to at least 2% of the weight of said yarn or fabric, wherein said yarn or fabric exhibits amine end groups at a concentration of at least 80 meq/kg and is obtained in a polymerization mixture comprising a nylon precursor comprising equimolar amounts of an amino groups source and a carboxy groups source, an alfa,omega diamine in an amount corresponding to between 0.5% and 2% of the amino groups contributed by said amino groups source, and optionally a phosphorus catalyst, in an amount of up to 100 ppm relatively to said precursor, having a formula
[R—HP(═O)—O]ₙ-M or R—HP(═O)—OZ
wherein M is a metal preferably selected from the group consisting of sodium, potassium, calcium, barium, and lithium; R is selected from the group consisting of hydrogen, alkyl, cycloalkyl, aryl, and arylalkyl; n is a whole number corresponding to the valence of the metal; and Z is selected from the group consisting of hydrogen, alkyl, aryl, arylalkyl, and alkyl substituted ammonium cation, with the proviso that R and Z are not simultaneously hydrogen; and R and Z being alkylene when joined to form a ring structure; wherein said precursor is a lactam, or a nylon salt consisting of equimolar amounts of alfa,omega diamine and alfa,omega dicarboxylic acid.

12. The system of claim 11, wherein said catalyst is employed in an amount of from 5 to 20 ppm.

13. The system of claim 11, wherein said polymerization mixture is heated in two stages, the first one at a pressure of 15-20 bar and the second one at a pressure of 0.7-0.9 bar.

14. The system of claim 11, wherein said salt is composed of equimolar adipic acid and hexamethylene diamine, and wherein said alfa,omega diamine is hexamethylene diamine in an amount of about 0.5% of the weight of said nylon salt, and said catalyst is sodium hypophosphite.
